(19) United States
(12) Patent Application Publication
(10) Pub. No.: US 2014/0130749 A1
(43) Pub. Date: May 15, 2014

(54) INTERACTIVE OUTDOOR BALL TOY FOR DOGS AND METHOD OF MANUFACTURE THEREOF

(71) Applicant: Varsity Pets, LLC, Salt Lake City, UT (US)

(72) Inventor: DANIEL SCHULOF, Salt Lake City, UT (US)

(73) Assignee: Varsity Pets, LLC, Salt Lake City, UT (US)

(21) Appl. No.: 14/073,102

(22) Filed: Nov. 6, 2013

Related U.S. Application Data
(60) Provisional application No. 61/724,994, filed on Nov. 11, 2012.

(51) Int. Cl. A01K 15/02; B29D 22/04

(52) U.S. Cl. CPC A01K 15/025; B29D 22/04
USPC 119/707; 264/311

(57) ABSTRACT

An interactive outdoor ball toy for dogs that includes a substantially sphere shaped toy ball with a hollow core and an exterior wall with a thickness. The toy ball has a diameter being 32 to 72 times the thickness. The exterior wall of the toy ball is made from a hard plastic with a consistent thickness and no holes or plugs.

### CROSS-REFERENCE TO RELATED APPLICATIONS

To the full extent permitted by law, the present U.S. Non-provisional patent application claims priority to and the full benefit of U.S. provisional Application entitled “Interactive Outdoor Toys for Dogs,” having assigned Ser. No. 61/724,994, filed on Nov. 11, 2012, incorporated herein by reference in its entirety.

### TECHNICAL FIELD OF THE INVENTION

The disclosure generally relates to non-food products and toys for pets, and more specifically to interactive outdoor toys for dogs.

### BACKGROUND OF THE INVENTION

Most healthy domestic dogs enjoy playing with toys in an outdoor environment. Such outdoor play is desirable for dog owners not only because of the enjoyment that it provides for their dogs, but also because outdoor play is a form of exercise that is beneficial for the health of the animals. Canine outdoor play behavior takes many forms, many of which revolve around ball toys and other kinds of toys.

Many dogs are highly motivated by instinctual drives to gather, drive, and/or herd animals and other movable objects. With or without the direction of a handler, such instincts often manifest in a form of outdoor play behavior in which dogs gather, drive, herd, or otherwise interact with large, mobile ball toys by rolling said toys along an outdoor surface. Accordingly, the ball toys that play an indispensible part of the play process are valuable to dog owners.

Some of the problems associated with known toys for dogs are that they are not durable and resistant enough to canine-inflicted scrapes, scratches, and punctures, some toys do not roll well on common outdoor surfaces, and/or some toys are too heavy for their pets to manipulate. As such, ball toys are of particular value to dogs and their owners when they bear the following qualities: extreme durability and resistance to canine-inflicted scrapes, scratches, and punctures; exterior shape and surface texture that permits the toy to roll freely on common outdoor surfaces such as grass, sand, concrete, and dirt when force is applied to the toy by a human or dog; and a relatively light weight that allows dogs to gather, drive, or herd the toy without excessive effort. Such qualities result in an optimal outdoor play experience for many dogs.

The instant disclosure is designed to provide and interactive outdoor ball toy for a dog that addresses at least some of the above mentioned problems.

### SUMMARY

Briefly described, in select embodiments, the present disclosure of an interactive outdoor toy ball for dogs includes toy ball with a hollow core and an exterior wall with a thickness. The toy ball has a diameter being 32 to 72 times the thickness. The exterior wall of the toy ball is made from a hard plastic with a consistent thickness and no holes or plugs.

These and other features of the interactive outdoor ball toy for dogs will become more apparent to one skilled in the art from the prior Summary, and following Brief Description of the Drawings, Detailed Description, and Claims when read in light of the accompanying Detailed Drawings.

### BRIEF DESCRIPTION OF THE DRAWINGS

The present interactive outdoor ball toy for dogs will be better understood by reading the Detailed Description with reference to the accompanying drawings, which are not necessarily drawn to scale, and in which like reference numerals denote similar structure and refer to like elements throughout, and in which:

FIG. 1 is a cross-sectional view of one embodiment of the interactive outdoor ball toy for dogs according to the instant disclosure.

FIG. 2 is a flow chart of one embodiment of the method of making the interactive outdoor ball toy for dogs according to the instant disclosure.

It is to be noted that the drawings presented are intended solely for the purpose of illustration and that they are, therefore, neither desired nor intended to limit the disclosure to any or all of the exact details of construction shown, except insofar as they may be deemed essential to the claimed disclosure.

### DETAILED DESCRIPTION

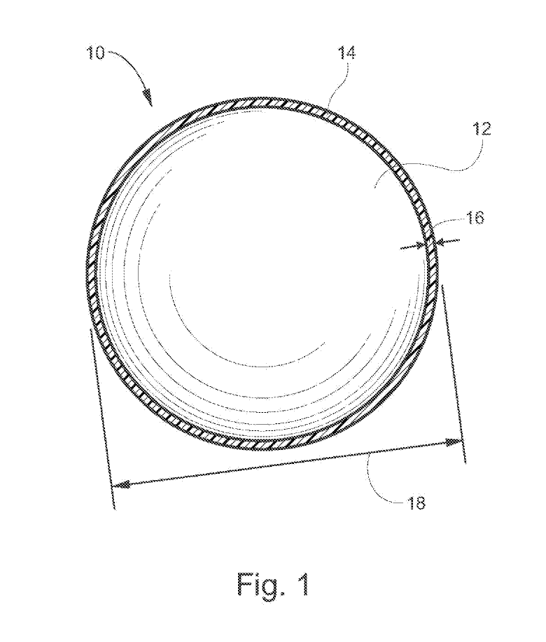

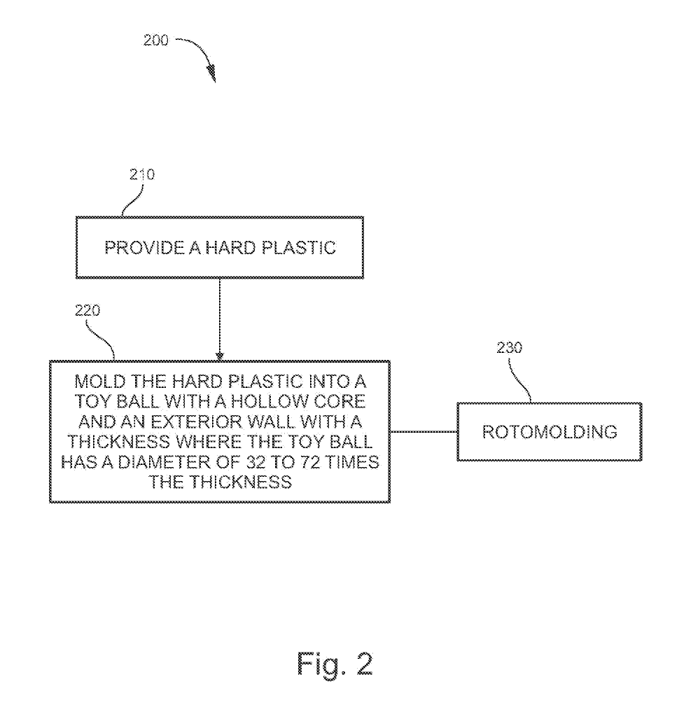

In describing the exemplary embodiments of the present disclosure, as illustrated in FIGS. 1-2, specific terminology is employed for the sake of clarity. The present disclosure, however, is not intended to be limited to the specific terminology so selected, and it is to be understood that each specific element includes all technical equivalents that operate in a similar manner to accomplish similar functions. Embodiments of the claims may, however, be embodied in many different forms and should not be construed to be limited to the embodiments set forth herein. The examples set forth herein are non-limiting examples, and are merely examples among other possible examples.

Referring now to FIG. 1 by way of example, and not limitation, therein is illustrated an example embodiment interactive outdoor ball toy for dogs 10, wherein interactive outdoor ball toy for dogs 10 comprises a hollow core 12, a diameter 18, and an exterior wall 14 of consistent thickness 16 with no holes or plugs (i.e. the exterior wall is solid). The interactive outdoor ball toy 10 for dogs may provide an optimal outdoor play experience for many dogs. Embodiments of the toy ball disclosed may be highly durable but also highly mobile and relatively light in weight, due to the specific material composition of the toy, the rounded exterior shaping of the toy, and relative thickness of the material composing the walls of the toy.

Although the instant disclosure is directed herein toward a ball toy for dogs, the instant disclosure is not so limited to dogs or canines, and can be used for other pets and/or human play, or other uses for balls as one skilled in the art would readily understand.

In more detail, still referring to the toy ball depicted in FIG. 1, the interactive outdoor toy for dogs 10 may roll along whatever surface it is resting upon whenever sufficient force is applied to the outside surface of the exterior wall 14 of the toy ball disclosed.

The hollow core 12 may be included inside the ball toy 10. See FIG. 1. The hollow core 12 may be the interior of the ball toy 12 and may be completely hollow or empty. This may mean that ball toy 10 does not include any interior features, like noise devices, wobble effect devices or unbalancing weights or objects, devices with flavors or aromas, other known interior ball toy devices, the like, combinations thereof, etc.

In further detail, still referring to the ball depicted in FIG. 1, the shape of the exterior wall 14 of the outdoor ball toy for dogs 10 may be any ball shape, including, but not limited to, spherical or substantially spherical, football shaped, etc. In order to ensure the optimal balance of durability and lightness, the diameter 18 of the interactive ball toy for dogs at its widest point may measure approximately 32 to 72 times the thickness 16 of the exterior wall 14. In one embodiment, the diameter 18 may be 32 to 48 times the thickness 16 of exterior wall 14. In one embodiment, the diameter 18 may be 64 to 72 times the thickness 16 of exterior wall 14. In yet another embodiment, the diameter 18 may be 48 to 64 times the thickness 16 of exterior wall 14. In yet another embodiment, the diameter 18 may be approximately 56 times the thickness 16 of exterior wall 14.

The construction details of the toy ball as shown in

FIG. 1 are that the exterior wall 14 of the interactive outdoor ball toy for dogs 10 may be made of a hard plastic. In select embodiments, the hard plastic may have a consistent thickness, i.e. a thickness that does not vary more than 5%, plus or minus, throughout the exterior wall. In addition, the hard plastic may form a solid exterior wall, i.e., an exterior wall with no holes, plugs, the like, etc. This hard plastic may be sufficiently rigid and strong but not excessively heavy. In various select embodiments, the hard plastic may be characterized by many different desired properties, including, but not limited to, the flexural modulus of the material, the tensile strength, and/or the density. Regarding the flexural modulus, in one embodiment the hard plastic may have a 1% secant flexural modulus of greater than 50,000 psi per ASTM D 790. In another embodiment, the hard plastic may have a 1% secant flexural modulus of greater than 100,000 psi per ASTM D 790. In yet another embodiment, the hard plastic may have a 1% secant flexural modulus of approximately 110,000 psi per ASTM D 790. Regarding the tensile strength, in one embodiment the hard plastic may have a tensile strength at yield of at least 2000 psi per ASTM D 638. In another embodiment, the hard plastic may have a tensile strength at yield of at least 2500 psi per ASTM D 638. In yet another embodiment, the hard plastic may have a tensile strength at yield of approximately 2600 psi per ASTM D 638. Regarding the density and resulting low weight of the hard plastic, in one embodiment the density may be less than 1.5 g/cc per ASTM D 1505. In another embodiment, the density of the hard plastic may be less than 1.0 g/cc per ASTM D 1505. In yet another embodiment, the density of the hard plastic may be approximately 0.9395 g/cc per ASTM D 1505.

The hard plastic of the exterior wall 14 of the interactive outdoor toy ball 10 may be any hard plastics or other materials that meet at least one of the above desired properties. In one embodiment, the hard plastic may be a linear low density polyethylene, also known as LLDPE. Suitable linear low density polyethylene may be provided by the Lyondell Chemical Company of Houston, Tex. under the trade name Microthene® as product number MP643662 with a melt index of 3.6, a density of 0.9395 g/cc per ASTM D 1505, a 1% secant flexural modulus of 110,000 psi per ASTM D 790, and a tensile strength at yield of 2600 psi per ASTM D 638.

The interactive outdoor ball toy 10 for a dog of the instant disclosure may be made by many different manufacturing methods, including, but not limited to various molding processes. In one embodiment, the hard plastic may be rotomolded to form the exterior wall 14 of the toy ball 10. These molding processes, like rotomolding, may allow the exterior wall to be formed with a consistent thickness. In addition, these molding processes, like rotomolding, may allow the exterior wall to be formed as a solid wall with no holes, plugs, etc.

Referring now to FIG. 2, according to various embodiments of the instant disclosure various methods 200 of manufacturing or making the interactive outdoor ball toy for dogs is shown. In one embodiment, the method 200 may include a step 210 of providing a hard plastic, and a step 220 of molding the hard plastic into a substantially sphere shaped toy ball with a hollow core and an exterior wall with a thickness, where the toy ball has a diameter being 32 to 72 times the thickness. Step 220 of molding the hard plastic may include any steps for molding and any various molding steps. In one embodiment, step 220 of molding the hard plastic may include a step 230 of rotomolding the hard plastic into a substantially sphere shaped toy ball with a hollow core and an exterior wall with a thickness, where the toy ball has a diameter being 32 to 72 times the thickness.

In broad embodiment, the present disclosure is a hollow ball toy with an exterior wall composed entirely of linear low density polyethylene plastic or another plastic material that is sufficiently rigid and strong but not excessively heavy, the shape of which exterior wall includes at least one rounded curve and is symmetrical along at least one axis, and the diameter of which along its longest axis of symmetry measures approximately 32 to 72 times the thickness of the exterior wall.

The advantages of the present toy ball disclosure include, without limitation, that it is both extremely durable and relatively lightweight. Because of the rigidity of the material with which the exterior wall of the toy ball is composed, the curved and symmetrical shape of the exterior wall 14, and the relative thickness 16 of the exterior wall 14 with respect to the diameter 18 of the toy ball disclosed, dogs generally cannot penetrate or otherwise damage the exterior wall of the toy ball through ordinary play behavior. But the material composition and shape of the disclosure allows this durability to be achieved at a relatively light weight. This unique combination of durability and lightness ensures that the toy ball provides an optimal outdoor play experience for dogs.

The foregoing description and drawings comprise illustrative embodiments. Having thus described exemplary embodiments, it should be noted by those skilled in the art that the within disclosures are exemplary only, and that various other alternatives, adaptations, and modifications may be made within the scope of the present disclosure. Merely listing or numbering the steps of a method in a certain order does not constitute any limitation on the order of the steps of that method. Many modifications and other embodiments will come to mind to one skilled in the art to which this disclosure pertains having the benefit of the teachings presented in the foregoing descriptions and the associated drawings. Although specific terms may be employed herein, they are used in a generic and descriptive sense only and not for purposes of limitation. Accordingly, the present disclosure is not limited to the specific embodiments illustrated herein, but is limited only by the following claims.

What is claimed is:

1. An interactive outdoor ball toy for dogs comprising:
a toy ball with a hollow core and an exterior wall with a thickness;
said toy ball having a diameter being 32 to 72 times said thickness;
said exterior wall of said toy ball being made from a hard plastic.

2. The interactive outdoor ball toy for dogs of claim 1 wherein said hard plastic having a 1% secant flexural modulus of greater than 50,000 psi per ASTM D 790.

3. The interactive outdoor ball toy for dogs of claim 2 wherein said hard plastic having a 1% secant flexural modulus of greater than 100,000 psi per ASTM D 790.

4. The interactive outdoor ball toy for dogs of claim 1 wherein said diameter being 32 to 48 times said thickness.

5. The interactive outdoor ball toy for dogs of claim 4 wherein said diameter being 64 to 72 times said thickness.

6. The interactive outdoor ball toy for dogs of claim 1 wherein said hard plastic having:
a tensile strength at yield of at least 2000 psi per ASTM D 638.

7. The interactive outdoor ball toy for dogs of claim 6 wherein said hard plastic having:
a tensile strength at yield of at least 2500 psi per ASTM D 638.

8. The interactive outdoor ball toy for dogs of claim 1 wherein said hard plastic having:
a density of less than 1.5 g/cc per ASTM D 1505.

9. The interactive outdoor ball toy for dogs of claim 8 wherein said hard plastic having:
a density of less than 1.0 g/cc per ASTM D 1505.

10. The interactive outdoor ball toy for dogs of claim 1 wherein said hard plastic being a linear low density polyethylene.

11. The interactive outdoor ball toy for dogs of claim 10 wherein said linear low density polyethylene being rotomolded to form said exterior wall of said toy ball, where said exterior wall having a consistent thickness with no holes or plugs.

12. The interactive outdoor ball toy for dogs of claim 1 wherein said exterior wall includes at least one rounded curve and is symmetrical along at least one axis.

13. The interactive outdoor ball toy for dogs of claim 1 wherein said exterior wall having a substantially spherical shape or a football shape.

14. The interactive outdoor ball toy for dogs of claim 1 wherein said exterior wall being solid with no holes or plugs.

15. An interactive outdoor ball toy for dogs consisting of:
a toy ball with a hollow core and an exterior wall with a thickness;
said toy ball having a diameter being 32 to 72 times said thickness;
said exterior wall of said toy ball being made from a hard plastic.

16. The interactive outdoor ball toy for dogs of claim 15 wherein said hard plastic having:
a 1% secant flexural modulus of greater than 50,000 psi per ASTM D 790;
said diameter being 32 to 48 times said thickness;
a tensile strength at yield of at least 2000 psi per ASTM D 638; and
a density of less than 1.5 g/cc per ASTM D 1505.

17. The interactive outdoor ball toy for dogs of claim 15 wherein said hard plastic being a linear low density polyethylene.

18. The interactive outdoor ball toy for dogs of claim 17 wherein said linear low density polyethylene being rotomolded to form said exterior wall, said exterior wall being solid with no holes or plugs.

19. A method of manufacturing an interactive outdoor ball toy for dogs comprising:
providing a hard plastic;
molding said hard plastic into a substantially sphere shaped toy ball with a hollow core and an exterior wall with a thickness, where said toy ball having a diameter being 32 to 72 times said thickness.

20. The method of manufacturing an interactive outdoor ball toy for dogs of claim 19 wherein said molding step including rotomolding said hard plastic into a substantially sphere shaped toy where said exterior wall being solid with a consistent thickness and no holes or plugs.
